(19) United States
(12) Patent Application Publication
(10) Pub. No.: US 2004/0056651 A1
(43) Pub. Date: Mar. 25, 2004

(54) System for detecting a flip-lid position of a personal electronic device

(76) Inventor: Daniele Marietta Bersana, Turin (IT)

Correspondence Address: Brinks Hofer Gilson & Lione, P.O. Box 10395, Chicago, IL, 60610, US

(21) Appl. No.: 10/247,697

(22) Filed: Sep. 19, 2002

(51) Int. Cl. G01B 7/30; G01B 7/14

(52) U.S. Cl. 324/207.2; 324/207.22

(57) ABSTRACT

A system is presented for detecting the flip-lid position of an electronic device, such as a cellular telephone. A unipolar Hall Effect Sensor, mounted on the base unit of the electronic device, detects the magnetic field from a transducer mounted on the electronic device, such as the earpiece on the flip-lid of the cellular telephone. When the flip-lid and base unit are sufficiently open, the Hall Effect Sensor detects the decrease in magnetic field from the transducer and signals that the flip-lid is open.

### FIELD OF INVENTION

The present invention relates to personal electronic devices. More particularly, the present invention relates to a system for detecting a flip-lid position of a personal electronic device.

### BACKGROUND

Many personal electronic devices, such as cellular telephones, personal digital assistants (“PDAs”), and walkie-talkies, are packaged with flip-lids. Opening the flip-lid typically turns on the electronic device, and closing the flip-lid typically turns off the electronic device or places the electronic device in a “sleep” mode. The flip-lid may be moveably connected to a base unit of the electronic device through a hinge or other pivoting or swiveling mechanism to allow the flip-lid to move between the open and closed positions. Alternatively, the flip-lid may slide along the base unit to move between the open and closed positions.

Moreover, the flip-lids may include components of the electronic device. For example, the flip-lid of a cellular telephone typically includes an earpiece. The base unit of the cellular telephone typically includes a microphone so that the earpiece may be positioned at the user's ear and the microphone may be positioned at the user's mouth when the cellular telephone is in the open position. Alternatively, the flip-lid may include the microphone and the base unit includes the earpiece.

In the closed position, the cellular telephone is more compact for carrying because of the reduction in length. As another example, the flip-lid of the cellular telephone may include buttons for dialing telephone numbers and activating other functions of the cellular telephone. In the closed position, the flip-lid may protect the buttons and a display built into the base unit. Opening the flip-lid may activate the display, which is revealed upon opening the flip-lid, or activate other functions of the electronic device, such as activating illumination of the buttons and display.

Typically, the flip-lid includes at least one speaker, such as an earpiece of a cellular telephone, and a discrete permanent magnet, where the base unit includes a sensor that is sensitive to magnetic fields. When the flip-lid is in the closed position, the sensor detects the magnetic field of the permanent magnet due to the proximity of the permanent magnet. The permanent magnet and sensor avoid the use of mechanical switches for detecting the flip-lid position.

The permanent magnet is typically mounted in the flip-lid without regard to polarity, and therefore the sensor must have the capability of detecting magnetic fields of both north and south polarity. Additionally, the permanent magnet may have sufficient strength to erase information encoded on magnet strip cards, such as credit cards or identification cards. Further, the permanent magnet is another cost component of the electronic device in terms of the component and the labor costs of mounting the permanent magnet in the flip-lid. Yet further, the permanent magnet adds weight to the electronic device and uses space that could otherwise be used for electronic components or a larger sized battery. Therefore, there is a need for detecting the flip-lid position of the personal electronic device that dispenses with the inclusion of the permanent magnet in the flip-lid.

### BRIEF DESCRIPTION OF THE DRAWINGS

FIG. 1 is a diagram illustrating a side view of an electrical device;

FIG. 2 is a diagram illustrating a side view of an alternate configuration of the electrical device of FIG. 1;

FIG. 3 is a diagram illustrating a side view of one embodiment of an electrical device that includes a magnetic transducer in the flip-lid; and

FIG. 4 is a diagram illustrating dimensions of the personal electronic device of FIG. 3.

### DETAILED DESCRIPTION OF THE PRESENTLY PREFERRED EMBODIMENTS

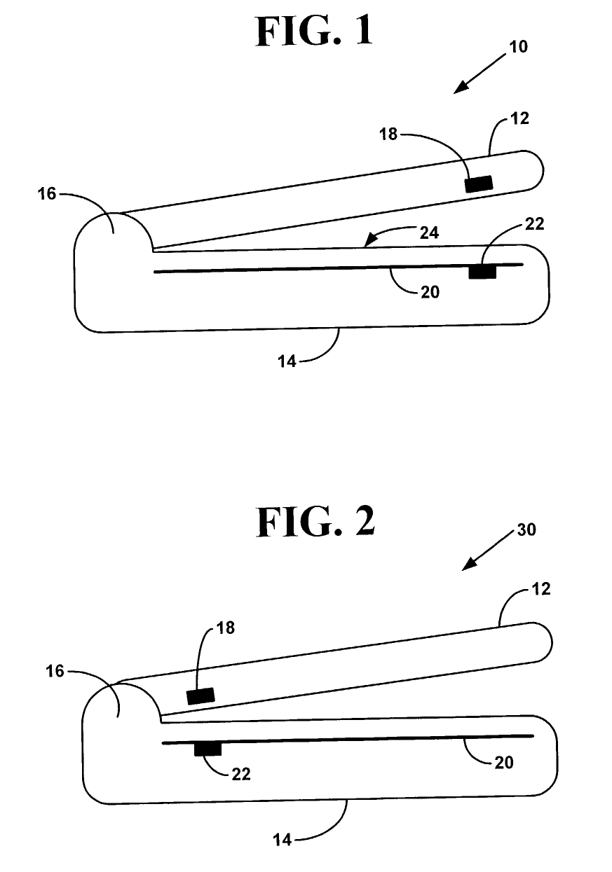

FIG. 1 is a diagram illustrating a side view of an electrical device 10. The electrical device 10 has a flip-lid 12 and a base unit 14 that are moveably connected at a moveable connection 16. The moveable connection 16 may be a pivot, such as a hinge. Another pivotable connection 16 is a swivel, where the flip-lid 12 and base unit 14 rotate relative to each other along a common perpendicular axis in moving from the open to closed position. A further moveable connection 16 is a slideable connection 16, where the flip-lid 12 and base unit 14 remain parallel along a common longitudinal axis but are relatively translated along the common longitudinal axis in moving from the open to closed position. The flip-lid 12 may fully overlap the base unit 14 in the closed position or may partially overlap the base unit 14 in the closed position.

In the case of the pivotal connection 16, for example, the flip-lid 12 is in the closed position when the flip-lid 12 is substantially parallel to the base unit 14, i.e., the angle between the longitudinal axes of the flip-lid 12 and base unit 14 is essentially zero. In the open position, the longitudinal axes of the flip-lid 12 and base unit 14 are at an angle that allows the user to view the top surface 24 of the base unit 14.

Flip-lids 12 are known to include a permanent magnet 18 while the base unit 14 includes a sensor 22, sensitive to magnetic fields, mounted on a circuit board 20. The permanent magnet 18 is typically composed of a rare earth magnetic material, such as Samarium-Cobalt or Neodymium-Iron-Boron, or a non-rare earth material, such as Alnico or ceramic ferrites.

When the flip-lid 12 is in the closed position, the sensor 22 detects the magnetic field due to the proximity of the permanent magnet 18. The sensor 22 and permanent magnet 18 may be situated respectively on the circuit board 20 and in the flip-lid 12 far from the moveable connection 16 as shown in FIG. 1. FIG. 2 is a diagram illustrating a side view of an alternate configuration of the electrical device 30 of FIG. 1. In the personal electronic device 30 of FIG. 2, the sensor 22 and permanent magnet 18 are situated respectively on the circuit board 20 and in the flip-lid 12 proximate to the moveable connection 16.

The flip-lid 12 also typically contains a transducer (not shown), such as the earpiece or the microphone as described above. The transducer may comprise a voice coil connected to a diaphragm, wherein the voice coil includes another permanent magnet. The voice coil in an earpiece moves the diaphragm to produce sound waves in response to current. The voice coil in a microphone produces current in response to sound waves on the diaphragm. The other permanent magnet in the voice coil is distinct from the permanent magnet 18 in the flip-lid 12 and does not participate in the detection of the flip-lid 12 position. It is only the proximity of the separate permanent magnet 18 and sensor 22 that detects the closed or open position of the flip-lid 12.

The sensor 22 is typically a Hall Effect Sensor (“HES”), which is a device that includes a semiconductor material exhibiting a Hall effect voltage in response to a magnetic field and also includes associated integrated circuitry that amplifies the voltage. The sensor 22 and permanent magnet 18 may be situated respectively on the circuit board 20 and in the flip-lid 12 far from the moveable connection 1 6 as shown in FIG. 1. FIG. 2 is a diagram illustrating a side view of an alternate configuration of the electrical device 30 of FIG. 1. In the personal electronic device 30 of FIG. 2, the sensor 22 and permanent magnet 18 are situated respectively on the circuit board 20 and in the flip-lid 12 proximate to the moveable connection 16 as shown in FIG. 2.

The permanent magnet 18 is typically mounted in the flip-lid 12 without regard to polarity. This mounting is done to reduce labor costs of consistently orienting the permanent magnet 18 and also to increase the reliability of manufacturing against incorrect orientation. Therefore the sensor 22 must have the capability to detect magnetic fields of both north and south polarity. Such a sensor 22 is a bipolar, or pole-independent, HES that detects the presence of the permanent magnet 18 regardless of which pole is facing the top surface 24 of the base unit 14. Typically, bipolar HES sensors are more expensive than unipolar, or pole-dependent, HES sensors and so the indiscriminate mounting of the permanent magnet 18 increases the cost of the personal electronic device 10, 30. Further, the permanent magnet 18 may have sufficient strength to erase information encoded on magnet strip cards, such as credit cards or identification cards. Therefore, there is a need for detecting the closed position of the personal electronic device 10, 30 that does not rely on a permanent magnet 18.

These considerations and costs associated with the permanent magnet 18 and bipolar HES 22 may be reduced by detecting the field of a magnetic transducer already present in the personal electronic device. For example, the field of a magnetic earpiece in a cellular telephone may have sufficient strength that a HES can determine the position of the earpiece on the flip-lid 12 with respect to the base unit 14. An advantage of using the magnetic field of the existing transducer to detect the closed position is that the transducer is mounted similarly on each personal electronic device and each transducer magnet has a common polarity. Because the sensor detects magnetic fields of one polarity, the sensor can be a unipolar HES of lower cost. Further, the magnetic field of the electronic device is reduced without the permanent magnet 18 and is less likely to damage magnetic strip cards.

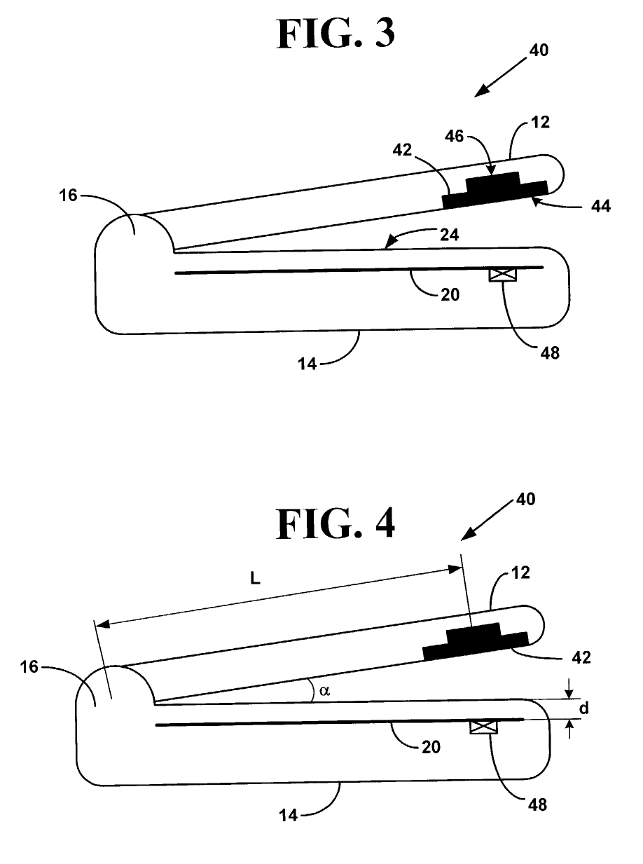

FIG. 3 is a diagram illustrating a side view of one embodiment of an electrical device 40 that includes a magnetic transducer 42 in the flip-lid 12. The transducer 42 has a front 44 and a back 46, and is mounted in the flip-lid 12 so that the front 44 faces the top surface 24 of the base unit 14 when the flip-lid 12 is closed. Examples of transducers 42 include speakers of laptop computers, walkie-talkies, or PDAs, and earpieces or microphones of cellular telephones. Other examples include alarm devices such as buzzers on PDAs and tremblers of cellular telephones that are used for silently alerting the user to an incoming call by causing the cellular telephone to mechanically vibrate. The transducers 42 are typically manufactured with a common magnetic orientation such that the front 44 of each manufactured transducer 42 exhibits the same magnetic polarity. The transducers 42 typically cannot be properly mounted in the flip-lid 12 with an incorrect orientation.

The base unit 22 includes a magnetic field detector 48, which may be mounted on a circuit board 20. In one embodiment, the magnetic field detector 48 is a reed switch that closes in the presence of a sufficiently strong magnetic field. In another embodiment, the magnetic field detector 48 is a HES. A HES has some advantages over a reed switch in that the HES is typically smaller and is not sensitive to mechanical vibrations of the electronic device 40.

A unipolar HES switches in response to a field of only one polarity. Examples of unipolar HES devices are the A3250 and A3251 devices manufactured by Allegro MicroSytems, Inc. of Worcester, Mass. A bipolar HES, however, responds to either magnetic polarity by reversing the directions of the current through the Hall element and/or reversing the voltage measurement points on the Hall element. Examples of bipolar HES devices are the A3209 and A3210 devices also manufactured by Allegro MicroSytems, Inc. of Worcester, Mass. Because the bipolar devices require more circuitry to be sensitive to magnetic fields of either polarity, the bipolar devices are typically more expensive than the unipolar devices.

Also, unipolar HES devices are typically more sensitive to magnetic fields than bipolar HES devices and may better detect the smaller magnetic field of the transducer 42. As the transducer 42 alone has a weaker magnetic field than in combination with the permanent magnet 18 of FIG. 1 and FIG. 2, there is less of a risk of damaging the information on a magnetic strip card if the card is in close contact with the personal electronic device 40. Further, in the embodiment illustrated in FIG. 3 there is reduced interference with the detection of the magnetic field of the transducer 42 from other magnetic field sources on the personal electronic device 40 because the permanent magnet 18 is absent.

In the closed position, the flip-lid 12 of the personal electronic device 40 is substantially parallel to the base unit 14. The front 44 of the transducer 42 is at its closest position to the unipolar HES 48. The magnetic field detected at the unipolar HES 48 is therefore at its highest value when the flip-lid 12 is in the closed position. As the angle at the moveable connection 16 between the flip-lid 12 and the top surface 24 of the base unit 14 increases, the distance between the front 44 of the transducer 42 increases and correspondingly the magnetic field strength at the unipolar HES 48 decreases. When the magnetic field strength at the unipolar HES 48 decreases below a predetermined trigger point value, the HES 48 switches to indicate to other components on the circuit board 20 that the flip-lid 12 is not in the closed position.

FIG. 4 is a diagram illustrating the dimensions of the personal electronic device 40 of FIG. 3. The distance between the moveable connection 16 and the transducer 42 is denoted L. The distance between the HES 48 and the transducer 42 in the closed position is denoted d. The angle between the flip-lid 12 and the base unit 14 is denoted α. The HES 48 switches to the state corresponding to the closed position when a falls below a closing angle α_{C}. Also, the HES 48 switches to the state corresponding to the open position when α rises above an opening angle α_{O}. Hysteresis of the HES 48 prevents an unstable trigger point. Increasing the hysteresis of the HES 48, for example by programming the HES 48, increases the difference between α_{O} and α_{C}.

Table 1 displays the dimensions and opening and closing angles for three makes of cellular telephones. The three cellular telephones are the models designated “V3688,” “V66,” and “T720,” which are manufactured by Motorola, Inc. of Schaumberg, Ill. The opening and closing angles are dependent on the dimensions of the cellular telephones and the transducer 42 in each respective cellular telephone, and the sensor 48 is an A3210 bipolar HES.

TABLE 1

| Model | L (mm) | d (mm) | α_{O} | αhd C |
|---|---|---|---|---|
| V3688 | 54 | 3 | 4° | 3° |
| V66 | 65 | 2 | 5° | 4° |
| T720 | 73 | 3 | 3° | 2° |

It should be understood that the above dimensions and angles are for illustrative purposes only and that other angles and dimensions are possible for other models of cellular telephones. Also, other angles are possible if the magnetic field strength of the transducer 42 is changed or a different HES 48 is used.

In personal electronic devices 40 whose operative transducer 42 is closer to the moveable connection 16, the opening and closing angles are expected to be larger because a larger angle a is required to separate the HES 48 and the transducer 42 to sufficiently weaken the magnetic field strength of the transducer 42.

Therefore, employing the magnetic field of the transducer 42 to operate the unipolar HES 48 disposes with the need for mounting a permanent magnet 18 in the personal electronic device, and disposes with the need for using a bipolar HES to detect the magnetic field change. Cost savings are from eliminating the labor costs of mounting the permanent magnet, eliminating the cost the permanent magnet itself, and using the cheaper unipolar HES 48. Additionally, the space and weight considerations of the separate permanent magnet are eliminated. The extra space may be used for including additional components of the electronic device 40, or for creating acoustical structures that enhance the sound quality of the transducer 42.

The foregoing detailed description is merely illustrative of several embodiments of the invention. Variations of the described embodiments may be encompassed within the purview of the claims. For example, the transducer 42 may be mounted in the base unit 14 and the sensor 48 mounted in the flip-lid 12. Accordingly, any description of the embodiments in the specification should be used for general guidance, rather than to unduly restrict any broader descriptions of the elements in the following claims.

I claim:

1. A system for detecting a flip-lid position of a personal electronic device, wherein the personal electronic device comprises a first section moveably connected to a second section, and wherein the system comprises:
a magnetic transducer mounted in the first section; and
a magnetic field detector mounted in the second section, wherein the magnetic field detector and the transducer are substantially proximate when the personal electronic device is in the closed position.

2. The system of claim 1 wherein the magnetic transducer comprises a voice coil of the personal electronic device.

3. The system of claim 3 wherein the voice coil comprises an earpiece of the personal electronic device.

4. The system of claim 3 wherein the voice coil comprises a microphone of the personal electronic device.

5. The system of claim 3 wherein the voice coil comprises a speaker of the personal electronic device.

6. The system of claim 1 wherein the magnetic transducer comprises an alarm of the personal electronic device.

7. The system of claim 6 wherein the alarm is a trembler comprises the personal electronic device.

8. The system of claim 1 wherein the magnetic field detector comprises a Hall Effect Sensor.

9. The system of claim 8 wherein the Hall Effect Sensor comprises a unipolar Hall Effect Sensor.

10. The system of claim 8 wherein the Hall Effect Sensor comprises a bipolar Hall Effect Sensor.

11. The system of claim 1 wherein the magnetic field detector comprises a reed switch.

12. The system of claim 1 wherein the personal electronic device comprises a cellular phone.

13. The system of claim 1 wherein the personal electronic device comprises a walkie-talkie.

14. The system of claim 1 wherein the personal electronic device comprises a personal digital assistant.

15. The system of claim 1 wherein the personal electronic device comprises a portable computer.

16. The system of claim 1 wherein the first section and second section are pivotally connected by a hinge.

17. The system of claim 1 wherein the first section and second section are pivotally connected by a swivel.

18. The system of claim 1 wherein the first section and second section are slideably connected.

19. A system for detecting a flip-lid position of a cellular telephone, wherein the personal cellular telephone comprises a flip-lid moveably connected to a base unit, and wherein the system comprises:
an earpiece which is mounted in the flip-lid; and
a Hall Effect Sensor mounted in the base unit, wherein the earpiece and the Hall Effect Sensor are substantially proximate when the cellular telephone is in the closed position.

20. The system of claim 19 wherein the Hall Effect Sensor comprises a unipolar Hall Effect Sensor.
